(19) United States
(12) Patent Application Publication
(10) Pub. No.: US 2010/0071994 A1
(43) Pub. Date: Mar. 25, 2010

(54) Multi-functional collapsible platform ladder of H shape

(76) Inventor: Chiu-Chu Tseng, Linbian Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,833

(22) Filed: Sep. 25, 2008

(51) Int. Cl. E06C 1/39; E06C 1/397; E06C 5/02; E06C 1/30

(52) U.S. Cl. 182/27; 182/119; 182/127

(57) ABSTRACT

The present invention is to provide a new multi-functional collapsible platform ladder of H shape, comprises a shelf rack, a pair telescopic ladders and a fixing framework, wherein the shelf rack are abutted and linked by a pair platform decks, and has hanger disposed at each distal outer ends thereof; the pair telescopic ladders are juxtaposed at each end of the shelf rack respectively with hanger of the shelf rack hooking on desired rung thereof; and the fixing framework comprises a pair foldable scaffolds, a pair joists and two pair tubular holders, which has a caster disposed thereof. By all foregoing parts, it can be transformed into H-shaped, Λ-shaped or single telescopic ladder with multiple functions and features in height adjustment and collapsibility to achieve effects of easy transportation and saving storing space.

### FIELD OF THE INVENTION

The present invention is to provide a new multi-functional collapsible platform ladder of H shape, particularly for one that people can stand or walk thereon when erected, and it can be transformed into H-shaped, Λ-shaped or single telescopic ladder with multiple functions and features in height adjustment and collapsibility to achieve effects of easy transportation and saving storing space.

### BACKGROUND OF THE INVENTION

Generally speaking, being limited by the physical, human working at height place must resort to the ladder to ascend. Per inspection, the conventional ladder is normally constructed by a top board docked with a pair of ladder frames in pivotal manner, which must be expanded outwards in form of approximate “A”s shape while in operation to let user for climbing and ascending to a height of desire.

However, the top board of the conventional ladder aforesaid usually affords a small area for single user to stand only, so the active space of the user is extremely confined in the small top board. Besides, when horizontal displacement is required at work, the user must leave the ladder first for moving the ladder to the appropriate place so that the subsequent work can proceed continuously, which can be regarded as a seriously boring issue to the user. Moreover, owing the conventional ladder being structure-fixed article, neither its height can be adjusted nor the flatness of its standing base can be leveled, which might incur safety issue of jeopardizing the user due to unevenness and rocking of the ladder.

Having realized the forgoing existing issues and drawbacks of the conventional ladder being never overcome, the inventor has undertaken research and development by addressing the issues and drawbacks as well as the ladder structure. After contrivance, test and constant improvement for a long time, eventually the present invention is worked out successfully.

### SUMMARY OF THE INVENTION

The primary object of the present invention is to provide a multi-functional collapsible platform ladder of H shape, whose material is selected from metal of iron, steel, aluminum alloy and rigid material of fiberglass, carbonated fiber or plastics, comprises a shelf rack, a pair of telescopic ladders and a fixing framework, wherein said shelf rack, which are abutted and linked by a pair of the platform decks in pivotal manner, has hanger disposed at each distal outer end corners thereof; said pair telescopic ladders are juxtaposed at each transverse end of the shelf rack respectively in symmetrically parallel manner with hanger of the shelf rack hooking on desired rung thereof; and said fixing framework mainly comprises a pair of inwards foldable scaffolds being able to folded towards each other, a pair of transverse joists and two pair of tubular holders, wherein each of said scaffolds has two slip retainers respectively erected at both top ends thereof for grasping the hollow upright tube of the telescopic ladder, each of said joists has two tubular holders respectively erected at both top ends thereof for holding the hollow upright tube of the telescopic ladder, and each of said tubular holder has a caster disposed at the outer end thereof.

The multi-functional collapsible platform ladder of H shape accords with aforesaid one, wherein each of said pair telescopic ladders comprises plural rungs, plural hollow upright tubes with different diameters in telescopic sleeve way by each other, plural jointers and plural manipulators, wherein each of said rungs crosses between corresponding pair hollow upright tubes, each of said hollow upright tubes has several latching holes on the tubular wall thereof, and connects with corresponding rung via a jointer, and each of said jointers mainly contains a manipulator therein. Said manipulator includes an unlocking element, a pair of positioning pin, a hollow junction fitting and an elastic component, wherein each said positioning pin is to insert into the hollow junction fitting such that the inner one extends towards the center of the rung to joint with the unlocking element while the outer one extends towards the hollow upright tube, said elastic component is disposed in the hollow junction fitting to push inwards against the positioning pin into a suitable latching hole of the hollow upright tube so that the rung is linked onto corresponding pair of hollow upright tubes in proper position, and said unlocking element serves to push outwards against the positioning pin off the latching hole.

The multi-functional collapsible platform ladder of H shape accords with aforesaid one, wherein said tubular holder has a swivel bar outwards extended at the bottom end thereof, said swivel bar has a receptacle set disposed at the end thereof, said receptacle set includes a clip, an eccentric pad, a pressing stem, plural padding bracers and an elastic component in downwards order such that each of eccentric pad, pressing stem and padding bracer has through hole created therein; said caster has a plugging stem configured on the top end thereof for passing through all the clip, eccentric pad, pressing stem, padding bracers and elastic component in the receptacle set thoroughly with extending end out of the receptacle set so that the clip can securely the plugging stem in proper positioning manner.

The multi-functional collapsible platform ladder of H shape in accordance with aforesaid one further comprises at least a clasping mount with two clasping trough being created at both lateral sides thereof to accommodate and clasp the top rung of the telescopic ladder so that a foldable ladder of “Λ” shape is completely assembled by the pair telescopic ladders.

### BRIEF DESCRIPTION OF THE DRAWINGS

FIG. 1 is the perspective appearance schematic view of the present invention.

FIG. 2 is the perspective exploded schematic view of the present invention.

FIG. 3 is the perspective exploded schematic view showing the telescopic ladder of the present invention.

FIG. 4 is the fractional perspective exploded schematic view showing the caster of the present invention in partial manner.

FIG. 5 is the cross section schematic view showing the assembly for the telescopic ladder of the present invention in full extending manner.

FIG. 6 is the fractional cross section schematic view showing the assembly for the fixing framework of the present invention in partial manner.

FIG. 7 is the operational schematic view showing the transformed ladder in Λ-shaped manner for the present invention.

FIG. 8 is the cross section schematic view showing the combinational state of the telescopic ladder and the clasping mount for the present invention.

FIG. 9 is the schematic view showing the collapsed state of the telescopic ladder for the present invention.

FIG. 10 is the cross section schematic view showing the collapsed state of the telescopic ladder for the present invention.

### DETAILED DESCRIPTION OF THE PREFERRED EMBODIMENT

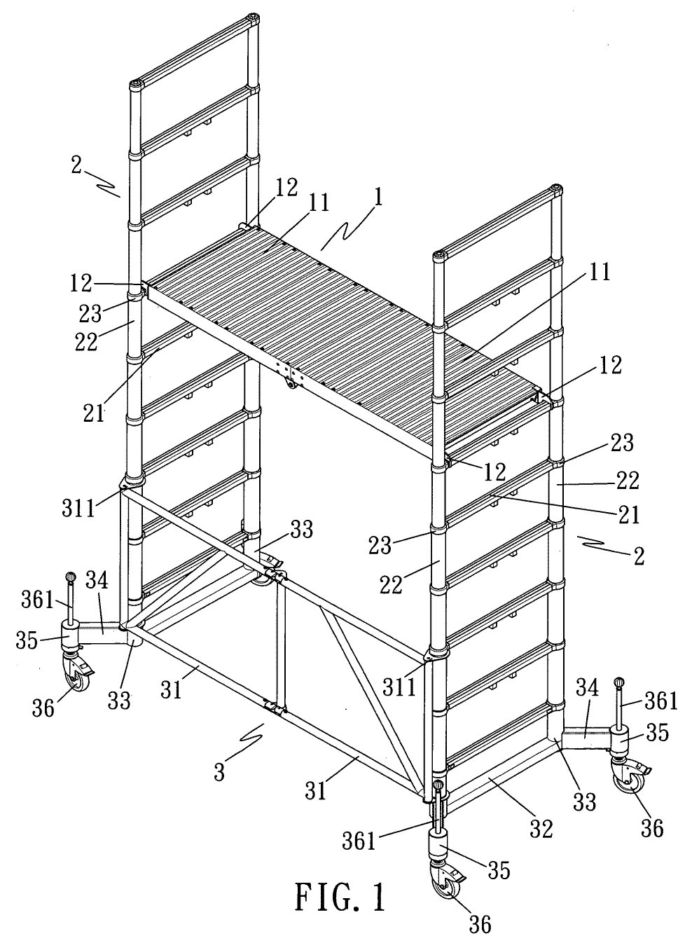

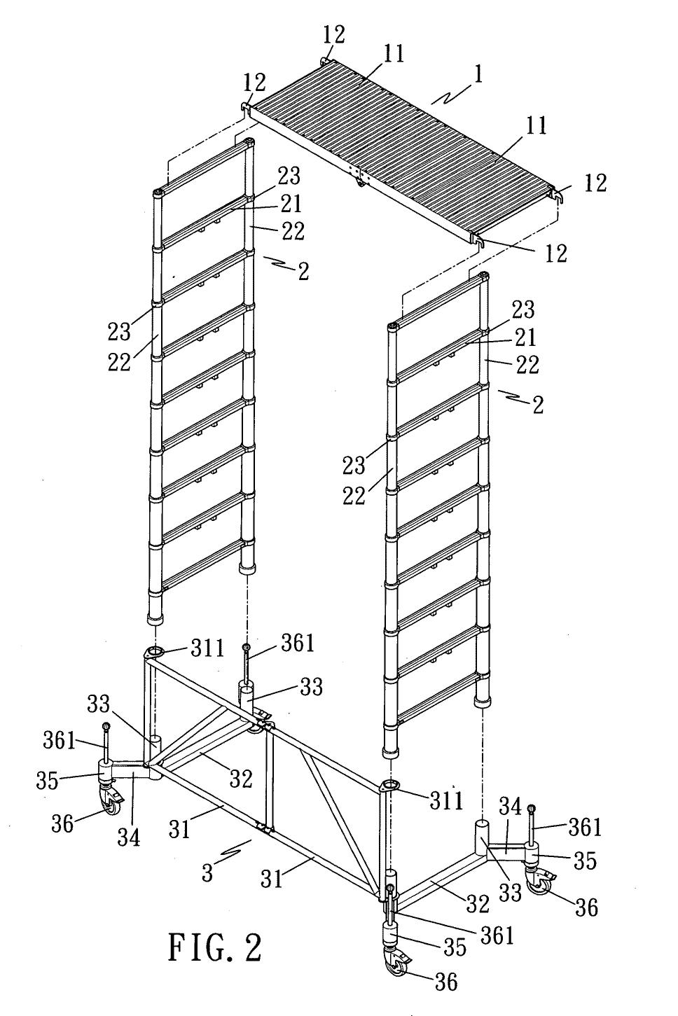

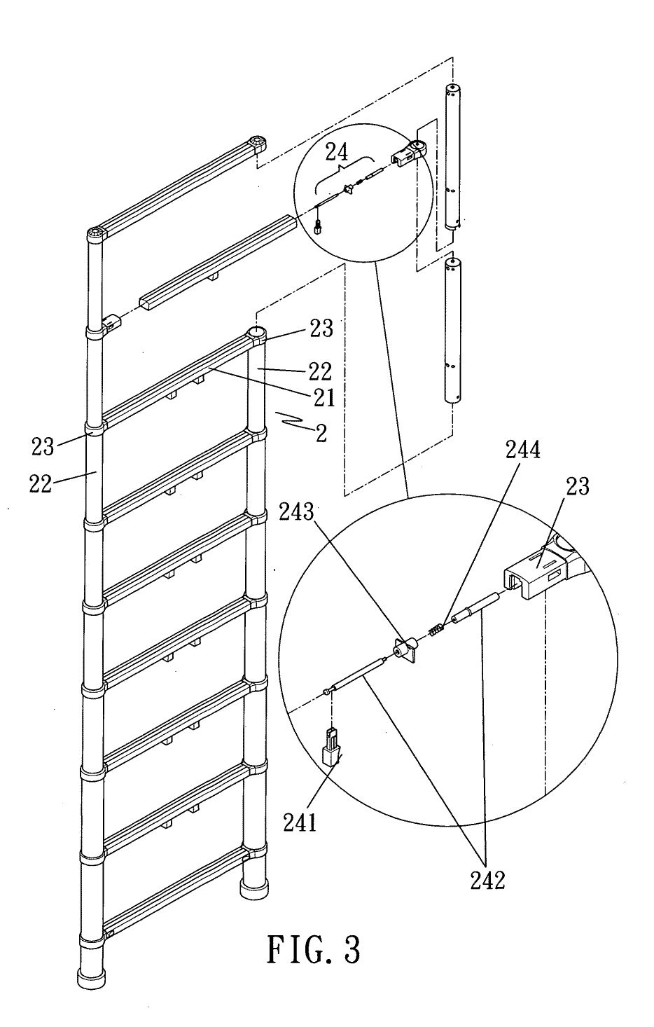

Regarding the technical means of the inventor, we here present a preferred exemplary embodiment with associated drawings to describe in detail manner for your better perusal, understanding and recognizing the present invention. Firstly, please refer to FIG. 1, which is the perspective appearance schematic view of the present invention, and FIGS. 2 through 4, which are the perspective exploded schematic views of the present invention. The material for making the collapsible platform ladder of H shape for the present invention can be selected from metal such as iron, steel, aluminum alloy and rigid material such as fiberglass, carbonated fiber or plastics and the so on. The multi-functional collapsible platform ladder of H shape comprises a shelf rack 1, a pair of telescopic ladders 2 and a fixing framework 3, wherein:

As shown in the FIGS. 1 and 2, said shelf rack 1, which are abutted and linked by a pair of the platform decks 11 in pivotal manner, has a pair of hangers 12 respectively disposed at each distal outer end corners thereof;

As shown in the FIGS. 1 through 3, said pair telescopic ladders 2 are juxtaposed at each transverse end of the shelf rack 1 respectively in symmetrically parallel manner with hanger 12 of the shelf rack 1 hooking on desired rung 21 thereof in arbitrarily selective height, each of which comprises plural rungs 21, plural hollow upright tubes 22 with different diameters in telescopic sleeve way by each other, plural jointers 23 and plural manipulators 24, wherein each of said rungs 21 crosses between corresponding pair hollow upright tubes 22, each of said hollow upright tubes 22 has several latching holes 221 on the tubular wall thereof, and connects with corresponding rung 21 via a jointer 23, each of said jointers 23 mainly contains a manipulator 24 therein,

Said manipulator 24 includes an unlocking element 241, a pair of positioning pin 242, a hollow junction fitting 243 and an elastic component 244, wherein each said positioning pin 242 is to insert into the hollow junction fitting 243 such that the inner one extends towards the center of the rung 21 to joint with the unlocking element 241 while the outer one extends towards the hollow upright tube 22, said elastic component 244 is disposed in the hollow junction fitting 243 to push inwards against the positioning pin 242 into a suitable latching hole 221 of the hollow upright tube 22 so that the rung 21 is linked onto corresponding pair of hollow upright tubes 22 in proper position, and said unlocking element 241 serves to push outwards against the positioning pin 242 off the latching hole 221; and

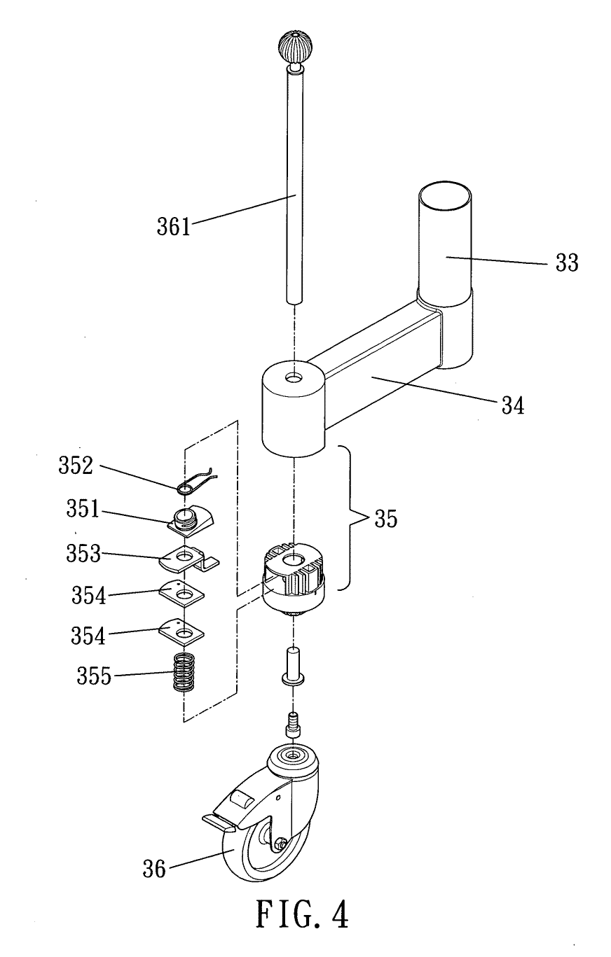

As shown in the FIGS. 1 and 2, said fixing framework 3 mainly comprises a pair of inwards foldable scaffolds 31 being able to be folded towards each other, a pair of transverse joists 32 and two pair of tubular holders 33, each of which includes a receptacle set 35 and a caster 36, wherein each of said scaffolds 31 has two slip retainers 311 respectively erected at both top ends thereof for grasping the hollow upright tube 22 of the telescopic ladder 2, each of said joists 32 has two tubular holders 33 respectively erected at both top ends thereof for holding the hollow upright tube 22 of the telescopic ladder 2 such that both scaffold 31 and joists 32 are jointed each other at each respective end in pairs as shown in the FIG. 4,

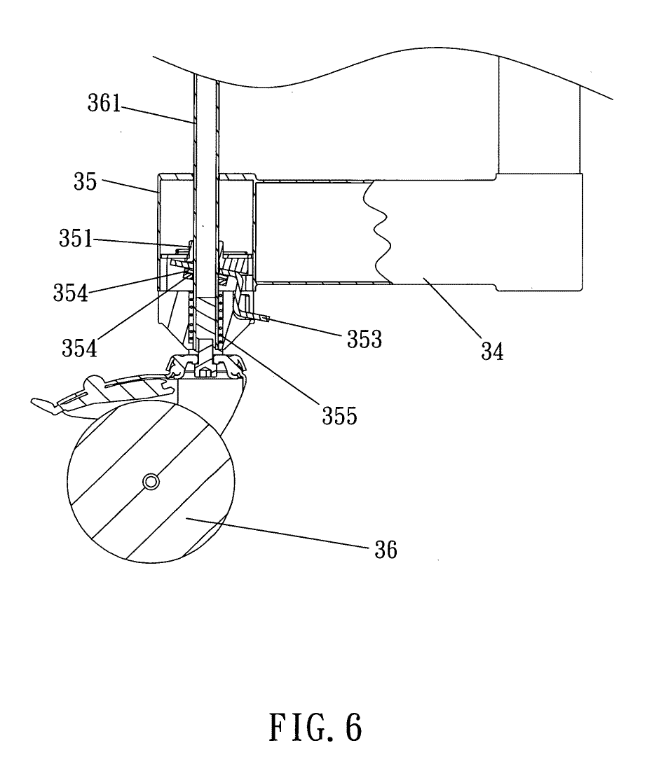

said tubular holder 33 has a swivel bar 34 outwards extended at the bottom end thereof, said swivel bar 34 has a receptacle set 35 disposed at the end thereof for being inserted by a caster 36 in proper position, said receptacle set 35 includes a clip 352, an eccentric pad 351, a pressing stem 353, plural padding bracers 354 and an elastic component 355 in downwards order such that each of eccentric pad 351, pressing stem 353 and padding bracer 354 has through hole created therein as shown in the FIGS. 4 and 6, said caster 36 has a plugging stem 361 configured on the top end thereof for passing through all the clip 352, eccentric pad 351, pressing stem 353, padding bracers 354 and elastic component 355 in the receptacle set 35 thoroughly with extending end out of the receptacle set 35 so that the clip 352 can securely the plugging stem 361 in proper positioning manner.

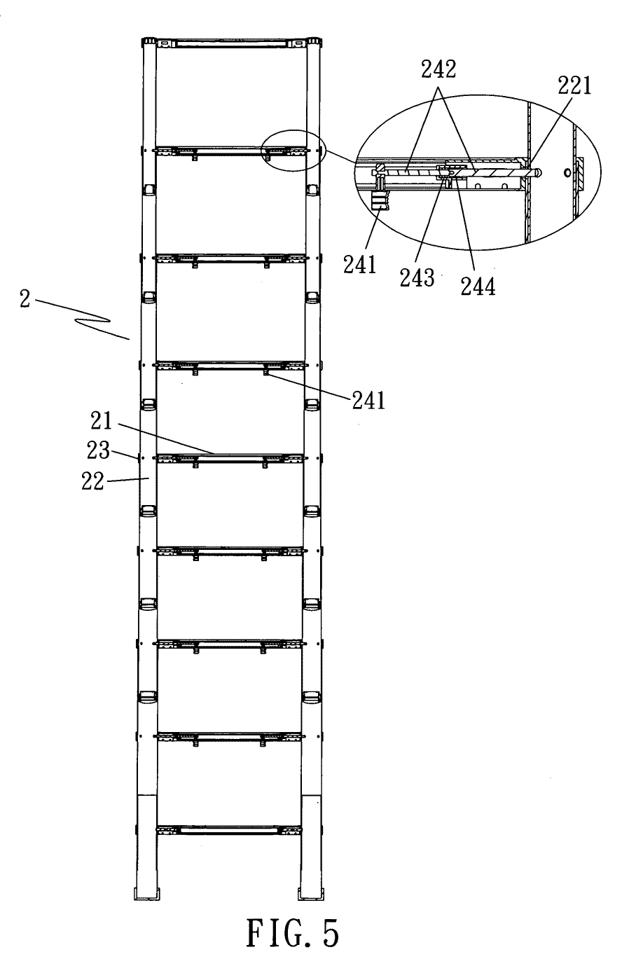

For assembling the multi-functional collapsible platform ladder of the present invention, all the foregoing parts are combined and jointed together as shown in the FIGS. 1 and 5 respectively.

Firstly, pull all the hollow upright tubes 22 of the telescopic ladder 2 up to full extension manner as shown in the FIG. 5;

Secondly, align the outer positioning pin 242 of the manipulator 24 suitably with latching hole 221 on the corresponding upright tube 22 so that the outer positioning pin 242 is pushed by the elastic component 244 outwards to insert into the latching hole 221 on the corresponding upright tube 22 with resulting telescopic ladder 2 for climbing usage as shown in the FIG. 5;

Thirdly, directly insert the undermost upright tubes 22 of the telescopic ladder 2 into the corresponding tubular holders 33 of the fixing framework 3 simultaneously; and

Finally, hook the hangers 12 of the shelf rack 1 directly onto the desired pair rungs 21 to compose a platform ladder as shown in the FIG. 1.

For operating the multi-functional collapsible platform ladder of the present invention, the height thereof can be adjusted to meet the requirement of the user by selectively hooking the shelf rack 1 directly onto the desired pair rungs 21.

If the user wants to work at higher place, he/she can pull the hollow upright tubes 22 of the telescopic ladder 2 in more or full extending manner to assemble a platform ladder at desired height in outwards open and stretching manner as shown in the FIG. 1. Conversely, If the user wants to work at lower place, he/she can pull the hollow upright tubes 22 of the telescopic ladder 2 in less or partial extending manner by the same token. Thus, the working space and range can be arbitrarily selected by the user to improve the working efficiency and convenience substantially, particularly being suitable for whitewashing wall, fixing wall fascia or car washing.

Besides, the multi-functional collapsible platform ladder of the present invention further has the preferable feature in easily movable displacement due to built-in casters 36 as shown in the FIG. 1. Because the fixing framework 3, where the telescopic ladders 2 are mounted thereon, has casters 36 disposed at the bottom, the platform ladder can be directly pushed by the user easily to desired working place effortlessly. Other than this convenient advantage, the built-in casters 36 has fine tuning capability of height adjustment via contrivance of the plugging stem 361 at the top end thereof and the receptacle set 35 at the distal end of the swivel bar 34. The height fine tuning procedure is described below with associated FIG. 6:

Please refer to FIG. 6. the pressing stem 353 and padding bracer 354 are configured into inclined state by the collocation of eccentric pad 351 and clip 352 to be passed through by the plugging stem 361 via each through hole thereof in proper position so that the inner wall of the padding bracer 354 is detached off the outer wall of the plugging stem 361 by simply pressing the pressing stem 353 to slightly push against the padding bracer 354 and elastic component 355. Thereby, the caster 36 is activated by the plugging stem 361 to ascend or descend so that not only the height of the caster 36 can be adjusted in accordance with the evenness of the working ground, where the ladder to be placed, but also the caster 36 is enabled to swivel freely.

Furthermore, excepting various advantages aforesaid, the multi-functional collapsible platform ladder of the present invention can be transformed into different ladder forms and types for different working purposes at the discretion of the user. To avoid long-winded redundancy, only two examples are presented for illustration.

### First Exemplary Transformation:

One single telescopic ladder 2 is adopted instead of a pair of which.

The single telescopic ladder 2 can be served as a conventional telescopic ladder for simple and easy working condition.

### Second Exemplary Transformation:

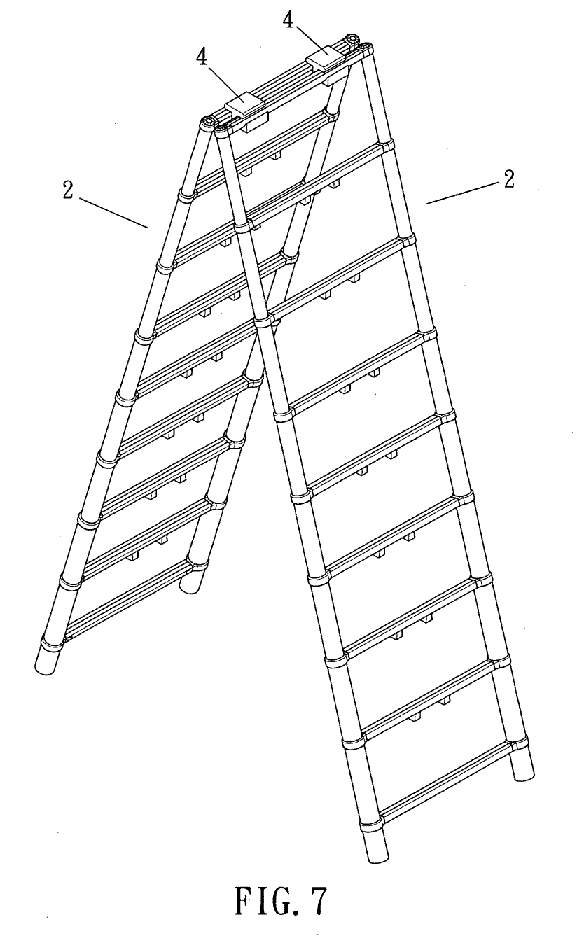

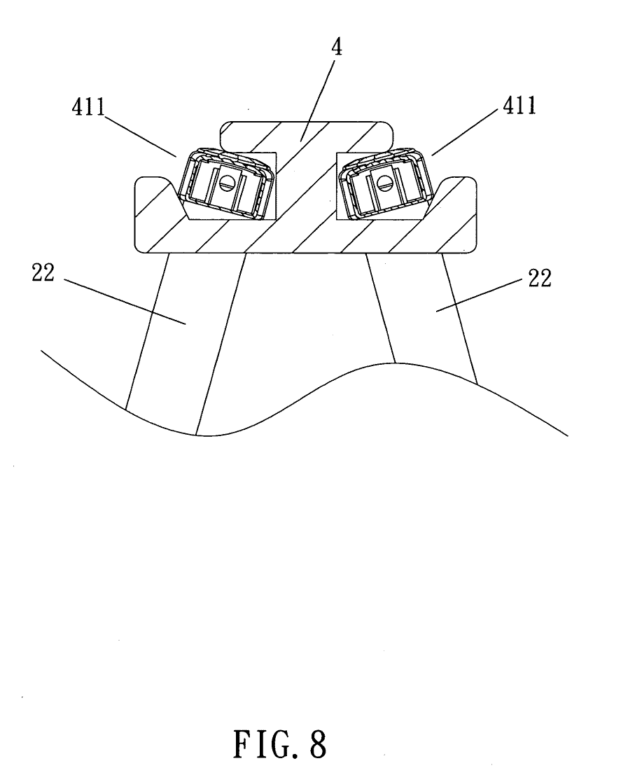

Please refer to FIG. 7. The platform deck 11 of the shelf rack 1 can be replaced by one or more clasping mount 4, which is a block with “I-shaped” cross section as shown in the FIG. 8. At each of both lateral sides of the clasping mount 4 is a clasping trough 41 with a raise-edged gap 411 such that the dimensional size of the clasping mount 4 is enough and suitable to accommodate and clasp the top rung 21 of the telescopic ladder 2 in proper latching tightness.

Thus, a foldable ladder of “Λ” shape is completely assembled by the pair telescopic ladders 2 by means of the clasping mounts 4.

For packing the multi-functional collapsible platform ladder of the present invention after usage, the steps of the collapsing procedure are described below:

Firstly, depart the shelf rack 1 away the telescopic ladder 2 and pull the telescopic ladder 2 off the fixing framework 3;

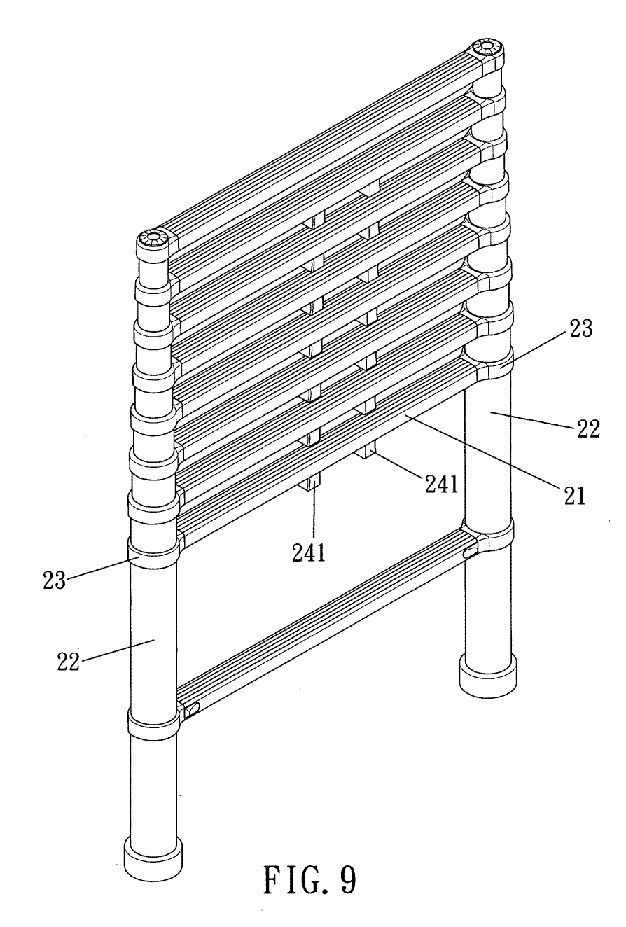

Secondly, fold inwards each of paired platform decks 11 of the shelf rack 1 towards each other in folded form as shown in the FIG. 9;

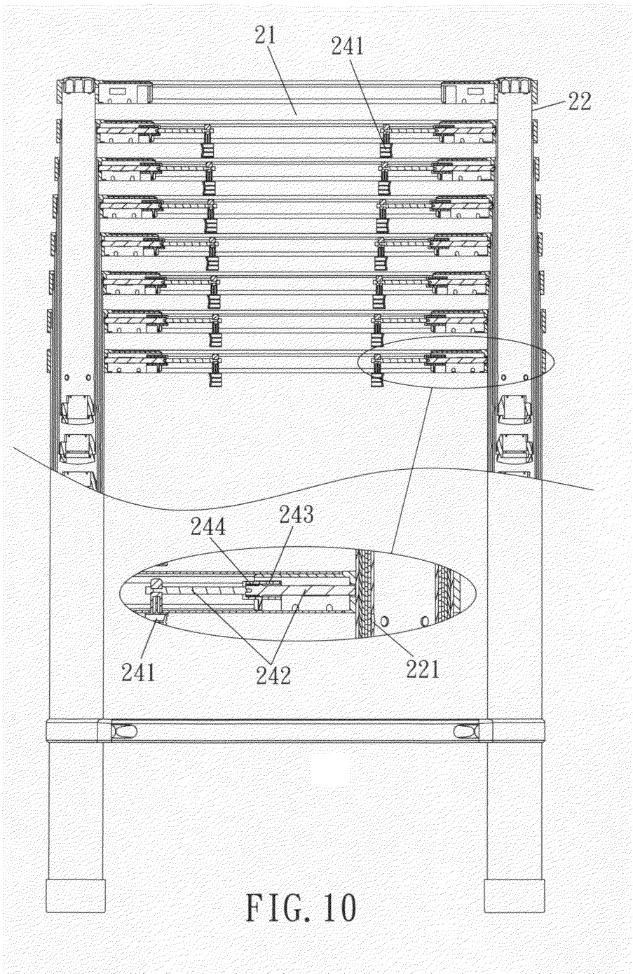

Thirdly, lower the telescopic ladder 2 down by pushing the unlocking element 241 of the manipulator 24 as shown in the FIG. 10 for activating the unlocking element 241 in pushing against the positioning pin 242 to separate off the latching hole 221 of the hollow upright tube 22 so that all the hollow upright tube 22 retracted into collapsed state and the height of telescopic ladder 2 is reduced thoroughly minimal state as shown in the FIGS. 9 and 10;

Finally, swivel inwards the caster 36 of the fixing framework 3 to collapse the fixing framework 3 into pre-collected form as shown in the FIG. 9, then orderly stack the collapsed shelf rack 1, telescopic ladder 2 and fixing framework 3 one by one in laminated manner.

Basing on the disclosure heretofore, it is known that the multi-functional collapsible platform ladder of the present invention has following advantages and effects:

### 1. Enlarge the Working Space:

Owing to the large area of the pair platform decks 1 of the shelf rack 1 in unfolding manner, the user can safely stand and walk thereon so that the working space is significantly enlarged to particularly be suitable for whitewashing wall, fixing wall fascia or car washing.

2. Reduce the Packing Size after Collapsing:

Owing to the collapsible and collectable features for all parts of the present invention in the course of collapsing and packing procedure, not only the collapsing and packing procedure is simple and quick but also the packing size is significantly reduced so that it is easily stored in the cabinet, under-bed space or car trunk.

### 3. Favor the Movement and Transportation:

Owing to the pair casters 36 disposed at both bottom ends of the fixing framework 3 respectively, the multi-functional collapsible platform ladder of the present invention becomes movable on the ground with resulting effect of reducing the inconvenience during transportation and the burden of the physical strength.

### 4. Transformable Feature for Different Usage:

By means novel design of the present invention, the multi-functional collapsible platform ladder of the present invention can be transformed into H-shaped platform ladder, Λ-shaped foldable ladder or single telescopic ladder and the like to meet the requirement of the user or in accordance with the confinement of the working place.

### 5. Ease the Adjustment of the Working Height:

Because the telescopic ladder 2 of the present invention comprises plural pair of hollow upright tubes 22 with different diameters and they sleeve each other in telescopic way, the telescopic hollow tubes 22 can be pulled in more or full extending manner for ladder of longer length or retracted in less or partial extending manner for ladder of shorter length at the discretion of the user so that not only the working height can be easily adjusted but also more options in overall height are provided.

In conclusion, the structural features disclosed in the present invention, which do achieve the expected objects and effects, and have practical value and property of advancement that means the present invention meets the basic patentability criterion of novelty, non-obviousness and practical industrial usage. Accordingly, we submit the patent application in accordance with the related patent laws for your perusal and examination with expectation and appeal for approving us a patent grant, which will be greatly appreciated by us. However, all the disclosure and illustrations heretofore are only the exemplary preferred embodiments, which are not intended for limiting the range of the embodiment for the present invention. Therefore, any equivalent alteration or modification, which does not depart from the claim range and specification essence of the present invention, should be reckoned as in the claim range of the present invention.

What is claimed is:

1. A multi-functional collapsible platform ladder of H shape, whose material is selected from metal of iron, steel, aluminum alloy and rigid material of fiberglass, carbonated fiber or plastics, comprises a shelf rack, a pair of telescopic ladders and a fixing framework, wherein the shelf rack, which are abutted and linked by a pair of the platform decks in pivotal manner, has hanger disposed at each distal outer end corners thereof; the pair telescopic ladders are juxtaposed at each transverse end of the shelf rack respectively in symmetrically parallel manner with hanger of the shelf rack hooking on desired rung thereof; and the fixing framework mainly comprises a pair of inwards foldable scaffolds being able to folded towards each other, a pair of transverse joists and two pair of tubular holders, wherein each of the scaffolds has two slip retainers respectively erected at both top ends thereof for grasping the hollow upright tube of the telescopic ladder, each of the joists has two tubular holders respectively erected at both top ends thereof for holding the hollow upright tube of the telescopic ladder, and each of the tubular holder has a caster disposed at the outer end thereof.

2. The multi-functional collapsible platform ladder of H shape is recited and claimed in the claim 1, wherein each of the pair telescopic ladders comprises plural rungs, plural hollow upright tubes with different diameters in telescopic sleeve way by each other, plural jointers and plural manipulators, wherein each of the rungs crosses between corresponding pair hollow upright tubes, each of the hollow upright tubes has several latching holes on the tubular wall thereof, and connects with corresponding rung via a jointer, and each of the jointers mainly contains a manipulator therein, The manipulator includes an unlocking element, a pair of positioning pin, a hollow junction fitting and an elastic component, wherein each the positioning pin is to insert into the hollow junction fitting such that the inner one extends towards the center of the rung to joint with the unlocking element while the outer one extends towards the hollow upright tube, the elastic component is disposed in the hollow junction fitting to push inwards against the positioning pin into a suitable latching hole of the hollow upright tube so that the rung is linked onto corresponding pair of hollow upright tubes in proper position, and the unlocking element serves to push outwards against the positioning pin off the latching hole.

3. The multi-functional collapsible platform ladder of H shape is recited and claimed in the claim 1, wherein the tubular holder has a swivel bar outwards extended at the bottom end thereof, the swivel bar has a receptacle set disposed at the end thereof, the receptacle set includes a clip, an eccentric pad, a pressing stem, plural padding bracers and an elastic component in downwards order such that each of eccentric pad, pressing stem and padding bracer has through hole created therein; the caster has a plugging stem configured on the top end thereof for passing through all the clip, eccentric pad, pressing stem, padding bracers and elastic component in the receptacle set thoroughly with extending end out of the receptacle set so that the clip can securely the plugging stem in proper positioning manner.

4. The multi-functional collapsible platform ladder of H shape as recited and claimed in the claim 1 further comprises at least a clasping mount with two clasping trough being created at both lateral sides thereof to accommodate and clasp the top rung of the telescopic ladder so that a foldable ladder of “Λ” shape is completely assembled by the pair telescopic ladders.
